(19) United States
(12) Patent Application Publication
(10) Pub. No.: US 2013/0288636 A1
(43) Pub. Date: Oct. 31, 2013

(54) LOCATION DATA UPDATING AND TRANSMISSION

(71) Applicant: Kelly Roy Peterson, Hanna City, IL (US)

(72) Inventor: Kelly Roy Peterson, Hanna City, IL (US)

(21) Appl. No.: 13/862,286

(22) Filed: Apr. 12, 2013

Related U.S. Application Data
(60) Provisional application No. 61/623,382, filed on Apr. 12, 2012.
(60) Provisional application No. 61/708,856, filed on Oct. 2, 2012.

(51) Int. Cl. H04W 4/22

(52) U.S. Cl. CPC H04W 4/22
USPC 455/404.2

(57) ABSTRACT

A method and apparatus store data for locations. Updates to the data for the locations are received and stored. In one implementation, a quick read location trigger is received image from a sender, wherein one of the locations is identified based upon the received quick read location trigger. In another implementation, one of the locations is identified based upon an identifier received from a computer aided dispatch. The data with the updates is transmitted to the sender of the quick read location trigger or to an emergency service provider while in transit to said one of the locations.

### CROSS REFERENCE TO RELATED APPLICATIONS

The present application claims priority under 35 USC 119(e) from co-pending U.S. Provisional Patent Application Ser. No. 61623382 filed on Apr. 12, 2012 by Kelly Roy Petersen, Sr. and entitled METHODOLOGY AND SYSTEM FOR SUPPORTING EMERGENCY RESPONSE UTILIZING TWO-DIMENSIONAL MATRIX BARCODE, the full disclosure of which is hereby incorporated by reference.

The present application claims priority under 35 USC 119(e) from co-pending U.S. Provisional Patent Application Ser. No. 61708856 filed on Oct. 2, 2012 by Kelly Roy Petersen, Sr. and entitled METHODOLOGY AND SYSTEM FOR SUPPORTING EMERGENCY RESPONSE UTILIZING TWO-DIMENSIONAL MATRIX BARCODE AND TRANSMISSION OF ON-SITE INTELLIGENCE DATA VIA MMS (MULTIMEDIA MESSAGING SYSTEMS) AND SMS LEFT FOR AN SHORT MESSAGE SYSTEMS) RELATE TO SMART MOBILE DEVICES FROM WEB-BASED PLATFORMS, the full disclosure of which is hereby incorporated by reference.

### BACKGROUND

Emergency response providers, such as firefighters, emergency medical providers and police, respond to a variety of emergencies in both residential and commercial establishments. During emergency responses, the emergency response providers frequently encounter previously unknown chemicals, containers under pressure and the like that may create dangerous circumstances for the providers. In many nonemergency circumstances, is also important for employees to be made aware of unknown chemicals and containers under pressure as well as any special precautions that should be taken. During emergency responses, the emergency response providers often consume valuable time attempting to make an initial assessment of the circumstances such as a building floor plan, where occupants may be located and the like. Such assessments are often based upon inaccurate and out of date information, leading to further dangerous circumstances.

### BRIEF DESCRIPTION OF THE DRAWINGS

FIG. 1 is a schematic illustration of an example location data updating and transmission system.

FIG. 2 is a schematic illustration of an example database of the system of FIG. 1.

FIG. 3 is a flow diagram of an example method that may be carried out by the system of FIG. 1.

FIG. 4 is a flow diagram of another example method that may be carried out by the system of FIG. 1.

FIG. 5 is a flow diagram of another example method that may be carried out by the system of FIG. 1.

### DETAILED DESCRIPTION OF THE EXAMPLE EMBODIMENTS

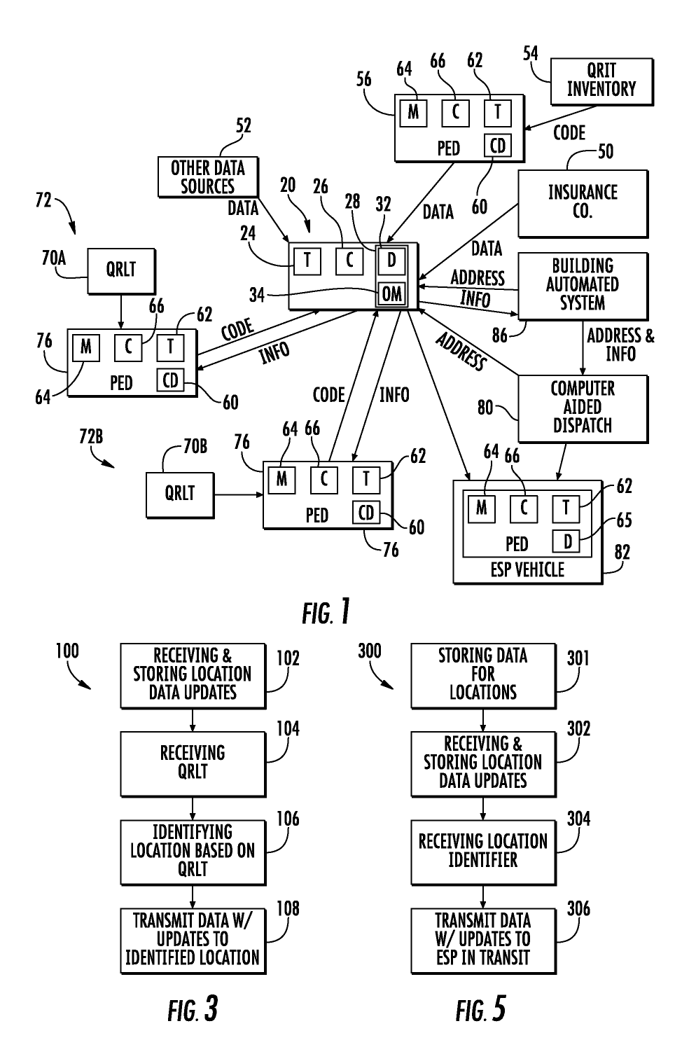

FIG. 1 schematically illustrates an example location data updating and transmission system 20. As will be described hereafter, system 20 provides emergency service providers or building occupants with easily updated and current information pertaining to a location. As a result, appropriate precautions may be implemented for safer emergency response or safer material handling.

As shown by FIG. 1, system 20 comprises transceiver 24, controller 26 and memory 28. Transceiver 24 comprises one or more different devices by which system 20 communicates with remote electronic devices. In one implementation, transceiver 24 facilitates bidirectional communication across a communications network, such as a telephone network, a wide area network (such as the Internet), a multimedia messaging system (MMS) and/or a short messaging system (SMS). In one implementation, transceiver 24 communicates from a web-based platform established by controller 26 and operating instructions contained in memory 28. In other implementations, transceiver 24 may communicate utilizing other communication networks or communication facilitators.

Controller 26 comprises one or more processing units which are configured to store location data, receive location data updates, receive location identifiers such as captured code images and transmits data and updates to the recipient. For purposes of this application, the term “processing unit” shall mean a presently developed or future developed processing unit that executes sequences of instructions contained in memory 28. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, controller 26 may be at least partially embodied as part of one or more application-specific integrated circuits (ASICs). Unless otherwise specifically noted, the controller is not limited to any specific combination of hardware circuitry and software, nor to any particular source for the instructions executed by the processing unit.

Memory 28 comprises a non-transient or non-transitory computer-readable medium or persistent storage device for storing data and operational instructions for controller 26. In particular, memory 28 comprises database 32 and operation module 34. Database 32 comprises a database containing data for various locations. Such data may be for particular buildings, for particular rooms in a building or for particular subdivisions, regions, areas or portions of a room in a building. Database 32 stores such data as well as updates for such data as will be described hereafter.

FIG. 2 illustrates one example of database 32. As shown by FIG. 2, database 32 comprises three fields for each location (location 1 . . . location n): a quick read location trigger field 40, a location detail field 42 and in information field 44. Quick read location trigger fields 40 comprise values associated with a quick read location trigger provided at each of the locations serviced by system 20. Quick read location triggers comprise electronic readable codes or electronic tags that are mounted at a location, such as on a wall or post, that may be quickly electronically read or scanned to trigger electronic retrieval of data regarding the particular location associated with the particular electronic code or tag. Each of such quick read location triggers is linked to location fields 42 and 44 in database 32 of system 20.

In one implementation, quick read location triggers comprise graphic codes. For purposes of this disclosure, a “graphical code” is a machine-readable graphic of lines, spots, bars, or symbols representing data in a codified manner, wherein the graphic is not alphanumeric and wherein the data represented by the graphic is not readily identifiable or capable of being understood without being translated using a code key for the graphic. Examples of graphical codes include, but are not limited to, quick response (QR) code, a two-dimensional barcode, a three dimensional barcode and a circular guilloche. In other implementations, different images of other types of graphical codes currently in existence or developed in the future may be utilized. In such an implementation, the graphical code is scanned in electronically read by an image capture device, such as a camera on a portable electronic device.

In another implementation, the quick read location trigger comprises an active or passive radio frequency identification (RFID) tag mounted or placed at the location, were in the RFID tag may be quickly electronically read, triggering electronic retrieval of data regarding the particular location associated with the particular electronic tag. In such an implementation, the trigger is read by an RFID reader carried by portable electronic device.

Upon receiving a graphical code via transceiver 24, controller 26 matches up the received graphical code to a graphical code contained in fields 40 to identify a particular location for which information from field 44 is to be retrieved and transmitted. The graphical code fields 40 may contain the actual graphical codes themselves or may contain values derived from the graphical codes.

Location details fields 42 comprise field of data comprising the actual address or other geographic identification of the particular location. For example, in one implementation, a location field 42 may comprise a global positioning system coordinates for the particular location, a street address for the particular location, one or more transit routes to a particular location and the like. In some implementations, the details of location fields 24 may be embedded into the graphical codes contained in fields 40 such that fields 42 may be omitted. In such an implementation, controller 26 simply reads the graphical code received via transceiver 24 to obtain the location details that might otherwise be provided in field 42.

Information fields 44 comprise fields of data containing information pertaining to the associated location. Such information fields 44 include originally submitted data as well as any updates that have been made to the data. Such updates may comprise additions to the original data or may comprise replacements or modifications to the original data. Examples of information that may be contained in one of more of fields 44 for locations provided in location fields 42 or identified by graphical codes in fields 40 include, but are not limited to, building floor plans, elevator shaft or stairway locations, building structural compositions (i.e., whether the building is a block building, has an I-beam construction, a wood composition, a brick composition or the like), occupant identification, number of occupants, occupant age, room types such as bedroom, occupant disabilities, the presence of tanks under high pressure, such as oxygen tanks, pet identification, number of pets, emergency contact data for occupants, hazardous on-site data such as the presence of hazardous chemicals on site, internal safety team contacts, employee rosters, on-site material safety data sheets, health hazards, fire hazards, reactive hazards and other specific hazards.

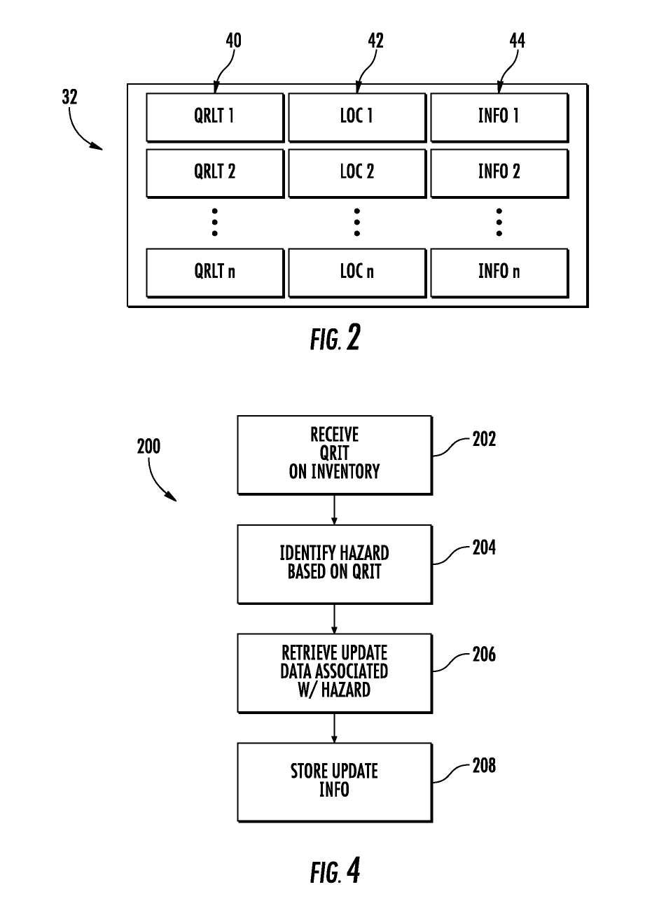

Operations module 34 comprise hard wired circuitry, code or software for directing operation of controller 26. Operations module 34 directs controller 26 to carry out methods for receiving and updating location data and transmitting such updated data to recipients such as individuals at the particular location to form such individuals the precautions that should be taken given the particular location or to recipients such as emergency service providers at the location or in transit to the location. FIG. 3 is a flow diagram illustrating one example method 100 that may be carried out by system 20 in accordance with instructions provided by operations module 34. As indicated by step 102, system 20 receives and stores location data updates from one or more various sources. Such location data updates are stored in fields 44 of memory 32 (shown in FIG. 2). In one implementation, the original information as well as updates to the information are received by system 20 from insurance companies 50 (shown in FIG. 1). Such insurance companies 50 transmit data already obtained by the insurance company as part of the premium quotation process by the insurance company 50. In another implementation, the original information as well as updates to the information are received from other data sources 52 (shown in FIG. 1). Other data sources 52 may comprise the owners of the building, the tenants of the building, private or governmental inspection records, mortgage or other appraisal records, and the like. In one implementation, system 20, automatically, on a periodic basis or other predefined intervals contact and requests updates to existing information from the insurance companies 50 or other data sources 52.

In one implementation, system 20 alternatively or additionally automatically maintains an updated inventory of material, health, fired, reactive and other hazards that may be currently located at a particular location. In other implementations, the owner, tenant or manager of the location update the records of system 20 with such updated inventory information. FIG. 4 is a flow diagram illustrating an example method 200 that may be carried out by system 20 to maintain a real time inventory of potentially hazardous materials at a particular site, such as a manufacturing/commercial establishment. As indicated by step 202, as new inventory is received by a commercial establishment/manufacturing establishment, such as at a receiving dock of the establishment, quick read inventory triggers 54 (shown FIG. 1) on the inventory (on the containers, packaging, pallets and the like) are scanned or otherwise captured. Quick read inventory triggers comprise electronic readable codes or electronic tags that are mounted to a container, pallet, package or the inventory itself that may be quickly electronically read or scanned to automatically trigger electronic updating of data regarding the particular material at the particular location.

In one implementation, quick read inventory triggers comprise graphical codes which may be read by an image capture device or camera of a portable electronic device or by a barcode reader other scanning reader of a portable electronic device. In another implementation, the quick read inventory trigger comprises an active or passive radio frequency identification (RFID) tag mounted or placed at the location, wherein the RFID tag may be quickly electronically read, triggering updating of inventory levels for the particular material that the particular location. In such an implementation, the trigger is read by an RFID reader carried by portable electronic device.

In the example illustrated in FIG. 1, such quick read inventory triggers 54 on the inventory are captured, scanned or read using a portable electronic device 56. As schematically shown by FIG. 1, portable electronic device 56 comprises capture device 60, transceiver 62, memory 64 and controller 66. Capture device 60 comprises a device to capture or read the quick read inventory trigger 54. In one implementation, capture device 60 may comprise a camera to capture an image of a graphical code serving as the quick read inventory trigger. In another implementation, capture device 60 may comprise a scanner or an RFID reader. In yet other implementations, capture device 60 may comprise other devices to capture the quick read inventory trigger 54.

Transceiver 62 comprises one or more devices that communicate with system 20. In one implementation, transceiver 62 communicates with system 20 in a wireless fashion across a communication network, such as a wide area network or Internet. In another implementation, transceiver 62 communicates with system 20 in a wired fashion.

Memory 64 comprises a non-transient computer-readable medium or persistent storage for storing data as well as operation instructions for controller 66. Controller 66 comprises one or more processing units for carrying out instructions contained in memory 64. In operation, controller 66, following instructions contained in memory 64, transmits data to system 20 in response to the receipt of quick read inventory trigger 54. In one implementation, the quick read inventory trigger 54 is itself transmitted to system 20, wherein system 20 updates information in fields 44 of memory 32 based upon the inventory trigger. In another implementation, controller 66 of portable electronic device 56 retrieves information based upon the received quick response inventory trigger 54, either from a database stored in memory 64 or from another remote source across a communication network, such as a web platform, wherein the information retrieved by portable electronic device 56 is transmitted to system 20.

As indicated by step 204 in FIG. 4, based upon the received quick read inventory trigger 54, the material being added to the inventory is identified and a determination of whether the material is hazardous is made. A hazardous material may be a material that is toxic or that releases toxic gases when heated or when burned. A hazardous material may be a material that is reactive or extremely flammable. A hazardous material may be a material that is stored under high pressure, such as an oxygen tank, susceptible to explosion in case of fire or other circumstances. A hazardous material may be a material that presents danger unless handled in a certain manner or certain precautions. A hazardous material may be one listed by certain governmental regulations such as OSHA and the like.

As noted above, in one implementation, a hazardous determination may be made by system 20. In another implementation, this determination may be initially made by electronic device 56, wherein portable electronic device 56 pre-filters data that is sent to system 20 such that only added inventory containing potentially hazardous or dangerous materials or conditions triggers the transmission of data to system 20. In some implementations, portable electronic device 56 may transmit the received quick read inventory trigger 54 to an intermediate computing device, such as a local server or local computing device for such pre-filtering to determine whether the inventory data represented by the quick response inventory trigger 54 is to be transmitted to system 20. For example, a manufacturing/commercial establishment may operate local server or computing device that prefilters such received inventory information based on the determination of whether the inventory being added is hazardous, wherein if the inventory being added is hazardous, the data is then submitted to system 20, which in some instances may be operated by a different entity or service provider operating under a fee or subscription.

As indicated by step 206, data associated with the material identified by the quick read inventory trigger is retrieved. For example, upon receiving a quick read inventory trigger 54 or upon receiving an identification of the inventory being added per the quick read inventory trigger 54, controller 26, following instructions contained in operations module 34, consults information contained in memory 28 or retrieves update information from an external data source using transceiver 24. Such update information or data may comprise a layman's name for the chemical identified by the quick response inventory trigger 54, flammability for the chemical, safety precautions for handling or use of the chemical and/or emergency response actions for the chemical. As noted in step 208, this additional supplemental information that is been retrieved by system 20 is then stored in memory 28, such as in the fields 44, for the particular location containing or storing the particular chemical or other hazardous material.

In one implementation, system 20 further automatically updates records regarding the presence of hazardous materials as such hazardous material inventories decline. For example, in one implementation, as containers of hazardous material or emptied, system 20 receives the quick read inventory triggers 54 for empty containers. In response, system 20 updates the quantity, volume or the like of the particular hazardous material at the particular location. If a hazardous material located at a particular location is moved to a different location (whether on premise at a particular commercial/residential establishment or moved off premises), the quick read inventory trigger 54 on the container, pallet, carton or the like containing a hazardous material is once again captured or read and the movement from one location to another location is detected and the records in database 32 are updated.

In one implementation, if the hazardous material is consumed as part of a manufacturing or production process, system 20 further updates the inventory records for the hazardous material. For example, in one implementation, particular hazardous materials may be consumed at a predefined rate for every product manufactured or at a predetermined rate over time or over manufacturing facility operational time. In such an implementation, system 20 may estimate or, for such consumption and periodically update database 32 with the new current volumes or amount of hazardous material located on premise or at a particular location.

As indicated by step 104 in FIG. 3, system 20 receives signals/code resulting from the capture or sensing of a quick read location trigger 70. As noted above, quick read location triggers 70 comprise placards, signs or other panels at various locations, wherein the triggers trigger the transmission of data for the particular location. In the example shown in FIG. 1, location 72 includes a first quick read location trigger 70A while location 72B includes a second quick read location trigger 70B which is different than the first quick read location trigger 70A. In the example illustrated, system 20 receives decoder signals produced as a result of the sensing or capture of the quick read location trigger 70 from a portable electronic device 76.

In the example illustrated, each portable electronic device 76 comprises capture device 60, transceiver 62, memory 64 and controller 66, described above. Capture device 60 is specifically configured to reader capture quick response location triggers 70 and to transmit the trigger 70 itself or code/values corresponding to the quick response location trigger 70 to system 20.

Transceiver 62 comprises one or more devices that communicate with system 20. In one implementation, transceiver 62 communicates with system 20 in a wireless fashion across a communication network, such as a wide area network or Internet. In another implementation, transceiver 62 communicates with system 20 in a wired fashion. Memory 64 comprises a non-transient computer-readable medium or persistent storage for storing data as well as operation instructions for controller 66. Controller 66 comprises one or more processing units for carrying out instructions contained in memory 64. In some implementations, portable electronic device 76 (as well as portable electronic device 56) may be embodied as part of a smart phone, a flash memory player, a computing tablet, a notebook computer, a laptop computer, a cell phone, a personal data assistant and the like.

In operation, controller 66, following instructions contained in memory 64, transmits data to system 20 in response to the receipt of quick read location trigger 70. In one implementation, the quick read location trigger 70 is itself transmitted to system 20. In another implementation, controller 66 of portable electronic device 76 retrieves information based upon the received quick read location trigger 70, either from a database stored in memory 64 or from another remote source across a communication network, such as a web platform, wherein the location retrieved by portable electronic device 76 is transmitted to system 20.

As indicated by step 106 in FIG. 3, system 20 utilizes the received quick read location trigger or the code/signals from the quick read location trigger to identify the particular location for which data is to be retrieved and transmitted. In particular, controller 26, following instructions provided in operations module 34, consults table 32 (shown in FIG. 2) to identify information to be transmitted for the particular location as identified by the quick read location trigger. As indicated by step 108, controller 26 transmits the retrieved data (from the particular field or fields associated with a particular location) to the identified location or to the sender (the portable electronic device 76 from which the QRLT was sent).

In one implementation, each of locations 72 comprises a display and transceiver for receiving the data for the location transmitted by system 20. In such an implementation, the display presents to a person the information for the particular location. In another implementation, a person may view the transmitter location from system 20 on a display of the particular portable electronic device 76. In an emergency situation, an emergency service provider, such as a firefighter, police officer, physician or the like may quickly and easily capture or scan the quick read location trigger 70 at the particular location and automatically receive on a portable electronic device display relevant information such as a floor plan, where occupants may be located, health conditions are special characteristics of such occupants, where hazardous chemicals, pressurized gases or the like may located, structural composition of the building or location. Because system 20 includes updates of information, the information and data received by the emergency service provider is more up to date, facilitating more appropriate precautions to reduce risk and danger.

In manufacturing or commercial settings, an employee at a particular location may quickly and easily capture or scan the quick read location trigger 70 at the particular location and automatically receive relevant information on a portable electronic device display (or other display) such as particular chemicals or hazardous materials at the particular location. System 20 provides a person making the request with updated information regarding the existence of hazardous chemicals or hazardous materials that the requester may be handling or with which the requester may be brought into contact. In one implementation, system 20 not only identifies the particular chemical, but provides the requester with a layman's name for the chemical, flammability for the chemical, safety precautions for the chemical and/or emergency response actions that should be taken if an accident occurs regarding handling or use of the chemical. As a result, system 20 better satisfies governmental regulations regarding the disclosure of hazardous chemicals (such as worker's “right to know” regulations) or materials as well as their handling. System 20 also further enhances safety awareness and safety response.

FIG. 5 is a flow diagram illustrating another example method 300 that may be carried out by controller 26 of system 20 in accordance with instructions provided by operations module 34. As indicated by step 301, system 20 stores data for various locations. Such data is stored in database 32 (shown in FIG. 2). As noted above, such data may be retrieved or received from outside entities such as insurance companies 50, the owners, occupants or tenants of a building or location or other data sources 52. As indicated by step 302, system 20 further receives and stores location data updates. Step 302 is similar to step 102 of method 100. The storing updates may involve the carrying out of method 200 described above with respect to FIG. 4. As a result, database 32 contains up-to-date information regarding hazardous chemicals or materials. Database 32 further contains up-to-date information regarding floor plans, occupancy and other information that may allow those on premises or emergency service providers to take appropriate precautions or take appropriate emergency response actions.

As indicated by step 304, system 20 receives a location identifier or address. In one implementation, system 20 receives the location identifier address from a computer aided dispatch 80 (shown in FIG. 1). In one implementation, the location identifier address is phoned into or otherwise communicated to an emergency response service associated with the computer aided dispatch 80. For example, a person may make a 911 phone call informing the service or computer-aided dispatch 80 of a fire, the need for a physician, the need for an ambulance or the like.

As indicated by step 306, upon receiving the address from the computer-aided dispatch, system 20 transmits data from database 32 with any updates to an emergency service provider (ESP) (also referred to as a first responder) while the ESP is in transit to the particular location. For example, system 20 transmits data a firefighter, police officer or physician in transit to a location as a result of the firefighter, please officer physician receiving the dispatch. Consequently, PSP may become quickly acquainted the circumstances prior to his or her arrival at the emergency scene, facilitating more timely and appropriate response to the situation.

In one implementation, service 20 may employ a server supporting a website accessible through the Internet or through another network by the computer aided dispatch 80. Upon receiving an emergency response request, the computer aided dispatch enters the address of the requester and identifiers of one or more emergency service providers on the website of service 20. The computer aided dispatcher at computer-aided dispatch 80 interacts with an icon or other graphical user interface of the website of service 20 to trigger or initiate the automatic transmission of the location information and updates by service 20 to the identified are selected one or more emergency service providers in transit or at the emergency location. In one implementation, the website of service 20 may further provide a list of emergency service providers (and potentially their availability) from which a dispatcher may select by interacting with graphical user interfaces of the website of service 20.

As shown by FIG. 1, computer-aided dispatch 80 may dispatch an emergency service provider vehicle 82 to a location for which data is stored in database 32 (shown in FIG. 2) vehicle 82 may be equipped with a portable electronic device or other electronic device which includes a transceiver 62, and memory 64, a display 65 and a controller 66. Transceiver 62 receive signals in a wireless fashion across a can be location network from system 20. In response to such signals, controller 66, following instructions contained in memory 64, displays or presents updated information on display 65. In one implementation, the information may be presented on multiple displays within an emergency response provider vehicle 82.

In one implementation, system 20 not only receives the address of the location to receive emergency services, but also receives a code or other emergency identifier identifying the type of emergency for which services are provided or the type of emergency service provider that has been dispatched. Based upon the emergency identifier (including the type of emergency service provider that is been dispatched), system 20 may select and transmit selected portions of information contained in database 32 to the emergency service provider in transit. For example, if the type of emergency is a particular type of fire, system 20 may transmit only types of information from field 44 of database 32 that may be relevant to a fire such as the presence of flammable chemicals, the location of flammable chemicals, the building or structure composition, the number and location of occupants, handicap or other characteristic of such occupants and the like. If the type of emergency is a request for an ambulance for a particular person, system 20 may only transmit a floor plan and the exact location of the person requesting the emergency medical assistance or may transmit physical characteristics of the person requesting the medical assistance. As a result, the emergency service provider is not overwhelmed with information that may be irrelevant, but is provided with filtered information most appropriate to the type of emergency being addressed.

In another implementation, system 20 may receive a location identifier or address (per step 304) directly from a building automated system 86 (such as a BACNET system) indicating an emergency incident (fire, chemical spill etc.). In response to receiving the location identifier, system 20 transmits the location information and updates (from database 32) to the building automated system 86. The location information and updates are then relayed by the building automated system 86, along with the address of the building, to the computer-aided dispatch 80 which forwards the emergency request along with the information and updates (from system 20) to the emergency service provider vehicle 82 in transit or to emergency service provider on-site (per step 306). In other implementations, system 20 may output updated information and data upon receiving an address from other sources, wherein the output information and data update are ultimately transmitted to the emergency service provider, either in transit or on-site, directly or through one or more other intermediaries.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method comprising:
storing data for locations;
receiving and storing updates to the data for the locations;
receiving a quick read location trigger from a sender;
identifying one of the locations based on the received quick read location trigger; and
transmitting the data with the updates for the identified one of the locations to the sender.

2. The method of claim 1, wherein receiving and storing updates for the locations comprises:
receiving a quick read inventory trigger associated with incoming inventory and one of the locations;
identifying update information based on the quick read inventory trigger; and
updating the records for said one of the location with the identified update information.

3. The method of claim 2, wherein the identifying the update information based on the captured code image comprises:
identifying a chemical from the quick read inventory trigger; and
retrieving update data associated with the chemical.

4. The method of claim 3, wherein the retrieved update data associated with the chemical is selected from a group of data consisting of: a layman's name for the chemical; a flammability for the chemical; safety precautions for the chemical; and emergency response actions for the chemical.

5. The method of claim 1, wherein the data comprise data selected from a group of data consisting of: floor plans; occupant identification; number of occupants; occupant age; and occupant bedrooms; occupant disabilities, oxygen tank presence; pet identification, number of pets; emergency contact data; hazardous on-site data internal safety team contacts; and employee rosters.

6. A method comprising:
storing data for locations;
receiving and storing updates for the locations;
receiving an identifier to find one of the locations from a computer aided dispatch;
transmitting the data with the updates for said one of the locations to an emergency service provider while in transit to said one of the locations.

7. The method of claim 6, wherein receiving and storing updates for the locations comprises:
receiving a quick read inventory trigger associated with incoming inventory and one of the locations;
identifying update information based on the quick read inventory trigger; and
updating the records for said one of the location with the identified update information.

8. The method of claim 7, wherein the identifying the update information based on the captured code image comprises:
identifying a chemical from the quick read inventory trigger; and
retrieving update data associated with the chemical.

9. The method of claim 8, wherein the retrieved update data associated with the chemical is selected from a group of data consisting of: a layman's name for the chemical; a flammability for the chemical; safety precautions for the chemical; and emergency response actions for the chemical.

10. The method of claim 6, wherein the data comprise data selected from a group of data consisting of: floor plans; structural composition information; occupant identification; number of occupants; occupant age; and occupant bedrooms; occupant disabilities, oxygen tank presence; pet identification, number of pets; emergency contact data; hazardous on-site data internal safety team contacts; and employee rosters.

11. An apparatus comprising:
a database storing data for locations;
a transceiver;
a controller to:
receive and store in the database updates to the data;
receive a captured code image from a sender;
identify one of the locations based on the received quick read location trigger; and
transmit the data with the updates for the identified one of the locations to the sender.

12. The apparatus of claim 11, wherein controller is further configured to:
receive a quick read inventory trigger associated with incoming inventory and one of the locations;
identify update information based on the quick read inventory trigger; and
update the database for said one of the location with the identified update information.

13. The apparatus of claim 12, wherein the identifying the update information based on the captured code image comprises:
identifying a chemical from the quick read inventory trigger; and retrieving update data associated with the chemical.

14. The apparatus of claim 13, wherein the retrieved update data associated with the chemical is selected from a group of data consisting of: a layman's name for the chemical; a flammability for the chemical; safety precautions for the chemical; and emergency response actions for the chemical.

15. The apparatus of claim 11, wherein the data comprise data selected from a group of data consisting of: floor plans; occupant identification; number of occupants; occupant age; and occupant bedrooms; occupant disabilities, oxygen tank presence; pet identification, number of pets; emergency contact data; hazardous on-site data internal safety team contacts; and employee rosters.

16. An apparatus comprising:
a database storing data for locations;
a transceiver;
a controller to:
receive and store in the database updates to the data;
receive an identifier to find one of the locations from a computer aided dispatch; and
transmit the data with the updates for said one of the locations to an emergency service provider while in transit to said one of the locations.

17. The apparatus of claim 16, wherein the controller is configured to receive and store updates for the locations by:
receiving a quick read inventory trigger associated with incoming inventory and one of the locations;
identifying update information based on the quick read inventory trigger; and
updating the records for said one of the location with the identified update information.

18. The apparatus of claim 17, wherein the controller is configured to identify the update information based on the quick read inventory trigger by:
identifying a chemical from the quick read inventory trigger; and
retrieving update data associated with the chemical.

19. The apparatus of claim 18, wherein the retrieved update data associated with the chemical is selected from a group of data consisting of: a layman's name for the chemical; a flammability for the chemical; safety precautions for the chemical; and emergency response actions for the chemical.

20. The apparatus of claim 16, wherein the data comprise data selected from a group of data consisting of: floor plans; occupant identification; number of occupants; occupant age; and occupant bedrooms; occupant disabilities, oxygen tank presence; pet identification, number of pets; emergency contact data; hazardous on-site data internal safety team contacts; and employee rosters.
